(19) United States
(12) Patent Application Publication
(10) Pub. No.: US 2024/0354601 A1
(43) Pub. Date: Oct. 24, 2024

(54) COMPUTER-IMPLEMENTED METHOD FOR PREDICTING THE BEHAVIOR OF A PARTICIPANT IN A TRAFFIC SCENE

(71) Applicant: Robert Bosch GmbH, Stuttgart (DE)

(72) Inventors: Max Keller, Korntal-Muenchingen (DE); Faris Janjos, Stuttgart (DE); Maxim Dolgov, Renningen (DE)

(21) Appl. No.: 18/608,534

(22) Filed: Mar. 18, 2024

(30) Foreign Application Priority Data
Apr. 20, 2023 (DE) 10 2023 203 666.5

(51) Int. Cl. G06N 5/022

(52) U.S. Cl. CPC G06N 5/022

(57) ABSTRACT

A computer-implemented method for predicting a behavior of at least one participant in a traffic scene. At least one AI-based prediction component is used to predict a specified number K of behavior options of the at least one participant for at least one future time segment on the basis of scene-specific information which are aggregated at a current time point. Each time segment includes a specified number T of consecutive time points. At least one current overall uncertainty value that quantifies the epistemic uncertainty of all predicted behavior options for the at least one future time segment is determined in parallel to the prediction of the individual behavior options.

### CROSS REFERENCE

The present application claims the benefit under 35 U.S.C. § 119 of German Patent Application No. DE 10 2023 203 666.5 filed on Apr. 20, 2023, which is expressly incorporated herein by reference in its entirety.

### FIELD

The present invention relates to a computer-implemented method for predicting a behavior of at least one participant in a traffic scene, in which at least one AI-based prediction component is used to predict a specified number K of behavior options of the at least one participant for at least one future time segment on the basis of scene-specific information which are aggregated at a current time point. Within the framework of such a prediction, several different behavior options are generally predicted for the participant. However, applications are also possible for which the prediction of only one behavior option is sufficient. Accordingly, K≥1 applies. The behavior of the participant is to be predicted for at least one future time segment, wherein each time segment comprises a specified number T of consecutive time points, i.e., T>1.

### BACKGROUND INFORMATION

In order to be able to plan safe and comprehensible maneuvers, automated vehicles must anticipate how the current traffic scene will develop and in particular how other participants in the traffic scene will behave in the future. For this purpose, future trajectories of vehicles, bicyclists, and pedestrians in the traffic scene, for example, are predicted and passed to the planning components of the automated vehicle. Traditional prediction methods generally carry out a prediction based on dynamics and can only model the interactions between road users to a limited extent. For this reason, the use of machine learning, in particular deep learning (DL), has been established as the de facto standard for prediction in recent years. Furthermore, in comparison to traditional prediction methods, machine learning methods offer the possibility of including extensive and diverse context information in the prediction.

Predicting the future is inherently uncertain and prone to errors, wherein a distinction must be made between the uncertainty of the future itself, which is referred to as aleatory uncertainty, and the uncertainty of predicting the future, which is referred to as epistemic uncertainty. Estimating the epistemic uncertainty of a prediction is of great importance, in particular for safety-critical applications. In automated driving, the epistemic uncertainty of the prediction should already be taken into account in the definition of system limits, i.e., in the definition of conditions that must be fulfilled for automated vehicle control. Furthermore, the epistemic uncertainty of the prediction should be taken into account in maneuver planning in order thus to improve the safety of automated driving.

The epistemic uncertainty of the prediction results from the plurality of variable influencing variables on the future development of a traffic scene. Furthermore, the future development of the traffic scene as well as environmental influences affect the performance of the perception means in aggregating and evaluating scene-specific information, which also contributes to the epistemic uncertainty of the prediction. Overall, the epistemic uncertainty of the prediction is subject to context-dependent fluctuations so that its estimation proves to be problematic in practice.

### SUMMARY

With the present invention, measures are provided that take into account the need to determine the epistemic uncertainty of the prediction. Furthermore, these measures also make it possible to capture the context-dependent temporal fluctuations of the epistemic uncertainty of the prediction.

According to an example embodiment of the present invention, this is achieved by determining at least one current overall uncertainty value that quantifies the epistemic uncertainty of all predicted behavior options for the at least one future time segment in parallel to the prediction of the individual behavior options.

It is important that the epistemic uncertainty of the overall prediction, i.e., of all predicted behavior options, is quantified by a common overall uncertainty value. According to the present invention, this overall uncertainty value is newly determined for each prediction step, i.e., in each case for the at least one future time segment for which the behavior of the participant is currently being predicted. Thus, a newly determined overall uncertainty value always represents the epistemic uncertainty for the current prediction step.

According to an example embodiment of the present invention, it has been found that, when using a suitable metric, the epistemic uncertainty of the overall prediction can be characterized very well by a common overall uncertainty value even for extremely complex constellations. This overall uncertainty value can then be taken into account very simply, and nonetheless sensibly, in the maneuver planning and also in the definition of the system limits in order to improve the safety of the overall system.

There are in principle different possibilities of determining a common overall uncertainty value for all predicted behavior options. All predicted behavior options can be taken into account or, for example, only a selection of the predicted behavior options.

In a preferred embodiment of the present invention, at least one respective current uncertainty value that quantifies the epistemic uncertainty of the predicted behavior option is determined for each predicted behavior option. Then, on the basis of all these current uncertainty values, the current overall uncertainty value is determined. For this purpose, the individual uncertainty values may, for example, be simply added up, or a mean value can be formed from the individual uncertainty values.

As mentioned above, the meaningfulness of the overall uncertainty value and also of the uncertainty values for the individual predicted behavior options depends on the metric used.

In a first embodiment of the present invention, a variance-based metric is used for determining the overall uncertainty value and also for determining the uncertainty values for the predictions of the individual behavior options. It is particularly advantageous that such a metric can be used for any type of AI-based prediction component to quantify the epistemic uncertainty of the prediction, i.e., the metric is universally usable in this respect.

To this end, several different predictions for each behavior option are generated on the basis of the currently aggregated scene-specific information. These different predictions then form the basis for determining a current uncertainty value for the respective behavior option. Preferably, a mean value of the variances between the different predictions over all time points of the at least one future time segment is formed for this purpose. That is to say, the variances between the different predictions are determined first, viz., for all parameters describing a behavior option and for all time points of the future time segment. A mean value is then determined from these variances.

In principle, there are different possibilities of inducing variance into the prediction and of generating a specified number of different predictions for a behavior option for given scene-specific input data, wherein these predictions should differ only somewhat but not fundamentally from one another.

A first possibility is to apply different types of noise to the currently aggregated scene-specific information for the different predictions.

According to a further possibility, any or specific weights of the AI-based prediction component could be modified, and in particular deactivated, for the different predictions by modifying them with a predetermined probability p or by setting them to 0. This process is referred to as Monte-Carlo dropout.

As an alternative to this “modification” of the prediction component, several different prediction components could also be used. Appropriate in this context is the use of several architecturally equivalent prediction components which however differ in the parameters learned, for example because they were each trained on a different composition of training data and/or different training configurations/training parameters were used. The predictions of the prediction components of such an ensemble will in that case at least partially differ so that, with given scene-specific input data, a variance of the prediction can be calculated for each behavior option.

A further embodiment of the present invention assumes that, for each of the behavior options, the behavior of the at least one participant in a future time segment i+1 is predicted starting from the actual or predicted behavior of the participant in the previous time segment i. In this embodiment of the present invention, a metric based on ascertaining a reconstruction error is used for determining the overall uncertainty value and the uncertainty values for the predictions of the individual behavior options. Accordingly, the quantification according to the present invention of the epistemic uncertainty of the prediction here requires a deep-learning (DL)-based reconstruction component in addition to the DL-based or AI-based prediction component.

For determining the uncertainty value for the prediction of a behavior option, the behavior of the participant in the previous time segment i is first reconstructed here on the basis of the behavior predicted for the future time segment i+1. Then, the behavior reconstructed for the time segment i is either compared to the actual behavior of the participant in the time segment i if the time segment i is in the past, or is compared to the predicted behavior of the participant for the time segment i if the time segment i is in the future. Finally, a current uncertainty value for the time segment i+1 is determined on the basis of this comparison.

Within the framework of the comparison between the reconstructed behavior and the actual or predicted behavior in the time segment i, the differences between the respectively corresponding parameters describing a behavior option are determined, viz., for all time points of the time segment i. These “reconstruction errors” then form the basis for determining a current uncertainty value for the respective behavior option. To this end, the reconstruction errors may be added up and/or averaged, for example. Since the reconstruction for the time segment i is based on the current prediction for the time segment i+1, the reconstruction errors make quantifying the current epistemic uncertainty of the prediction possible.

In an advantageous development of this variant of the method according to the present invention, not only the prediction of the behavior for the time segment i+1 but also further data aggregated in the past and/or predicted data, such as a latent scene representation or semantic information, such as the state of a traffic light circuit, etc. are taken into account in the reconstruction of the behavior of the participant for the time segment i.

It is particularly advantageous that none of the above-described method variants is limited to the prediction of behaviors in a particular representation. Thus, a behavior options of a participant may be predicted in the form of trajectory data comprising position data and/or movement data and/or orientation data for each time point of the at least one future time segment. Both of the metrics proposed here for quantifying the epistemic uncertainty of the prediction can be equally applied to all these representations.

### BRIEF DESCRIPTION OF THE DRAWINGS

The measures according to the present invention and preferred implementation options are explained in more detail below with reference to the figures.

FIG. 1 illustrates the functionality of a computer-implemented system according to an example embodiment of the present invention for carrying out a prediction method in connection with a perception component and a planning component of an automated vehicle using a block diagram.

FIG. 2 illustrates the use of a variance-based metric within the framework of a first variant of the method according to the present invention.

FIG. 3 illustrates the use of a reconstruction-error-based metric within the framework of a second variant of the method according to the present invention.

### DETAILED DESCRIPTION OF EXAMPLE EMBODIMENTS

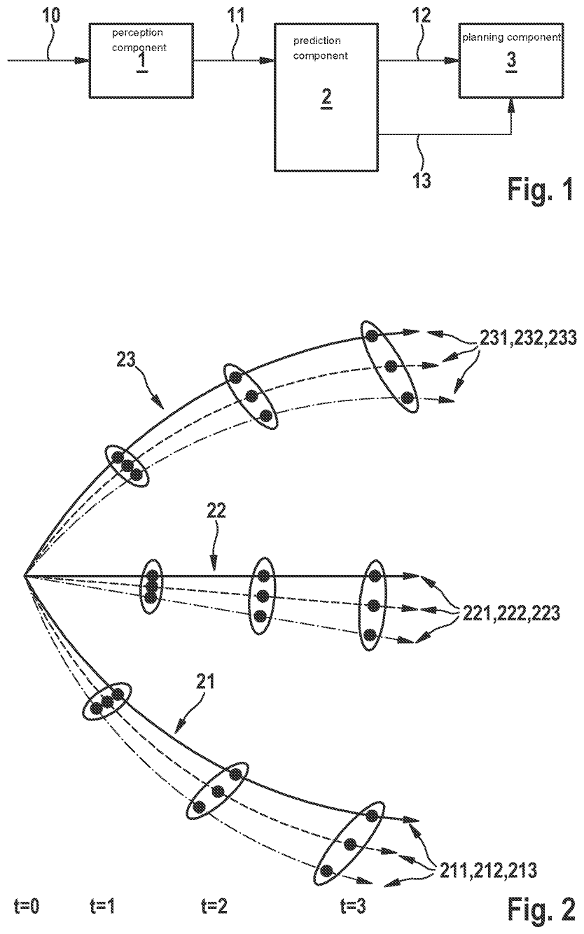

The block diagram of FIG. 1 shows a perception component 1 of an at least partially automated vehicle, which perception component aggregates scene-specific information 10 from different on-board and possibly also off-board sources of information. Generally, the scene-specific information 10 is data sensed by camera sensors, lidar sensors, and/or radar sensors. In addition, scene-specific information 10 can also be sensed by means of inertial sensors of the vehicle. The scene-specific information is also often supplemented by GPS data and map data, as well as weather data and road condition data. The scene-specific information 10 aggregated at a given time point generally includes the sensor data and other data that are current at this time point. However, it may also include sensor data and other data collected over a specified time period until the given time point.

The aggregated scene-specific information 10 is evaluated by the perception component 1 in order to recognize and locate objects and participants in the current traffic scene. Furthermore, the perception component 1 in the exemplary embodiment described here is equipped with a neural network in order to generate a set of latent features for each participant on the basis of the aggregated scene-specific information 10.

In the exemplary embodiment described here, these sets of latent features serve as input for an AI-based prediction component 2 of the vehicle. The neural network of the prediction component 2 predicts a specified number k of behavior options 12 for a participant, viz., for a future time segment, using the set of latent features 11 generated for this participant, wherein each time segment comprises a specified number t of consecutive time points. The prediction thus always takes place at least indirectly on the basis of the currently aggregated scene-specific information 10. The future behavior of the participant can, for example, be predicted in the form of trajectories, i.e., in the form of position data x, y of the participant for the t consecutive time points of the future time segment. In addition, the trajectory information can also include movement information for the participant, such as velocity data and acceleration data, and/or orientation information, and/or information on the spatial orientation of the user, e.g., in the form of steering angle information.

According to the present invention, the prediction component 2 is also designed, in parallel to the prediction of the individual behavior options 12 of a participant, to determine at least one current overall uncertainty value 13 which quantifies the epistemic uncertainty of all predicted behavior options 12 of this participant for the future time segment.

The behavior options 12 predicted for a participant are then supplied, along with the current overall uncertainty value 13, to a planning component 3 for vehicle maneuver planning so that the current epistemic uncertainty of the prediction can be taken into account in the maneuver planning.

Within the framework of the exemplary embodiments described below, the quantification of the current epistemic uncertainty of the prediction is carried out in each case on the basis of current uncertainty values, which are determined for the individual predicted behavior options. From the totality of these currently determined uncertainty values, a current overall uncertainty value for predicting all behavior options of a participant is then calculated.

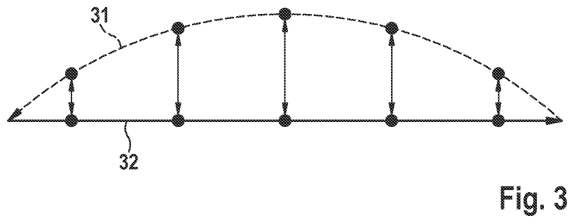

FIG. 2 illustrates the use of a variance-based metric to quantify the current epistemic uncertainty of the prediction of a prediction component 2 as described in connection with FIG. 1. Such a metric is also hereinafter referred to as predicted modes variance σx, y and is usable for any AI-based or DL-based prediction components. The predicted modes variance σx, y builds on any method that induces variance into the prediction in order to generate a specified number M of predictions for a behavior option of a participant on the basis of a given set of scene-specific information. Generally, the ≥1 most probable future trajectories are predicted as different behavior options for a participant.

By way of example, FIG. 2 shows M=3 predictions each for K=3 different behavior options 21, 22 and 23 in the form of trajectories 211, 212, 213; 221, 222, 223; and 231, 232, 233, each described by trajectory waypoint (x {t, k}, {t, k}), t∈[1; T=3]. All these trajectories 211, 212, 213; 221, 222, 223; and 231, 232, 233 were predicted at a given time point 0 for a future time segment t∈[1; T=3] on the basis of a given set of scene-specific information. The predictions for a behavior option 21, 22 or 23 only slightly differ from one another in each case due to the variance-inducing method.

Now, for each of the k∈[1; K=3] behavior options 21, 22 and 23, the variances between the M=3 different predictions are determined separately. For this purpose, for each trajectory waypoint (x {t,k}, {t, k}), t∈[1; T=3] of a predicted trajectory, the variance in the x-direction σ2 (xt, k) and the variance in the y-direction σ2 (yt, k) between the M=3 predictions are determined. The variance of the trajectory waypoints is represented here by ovals. In this case, only the diagonal elements of the covariance matrix are used, but all elements of the covariance matrix can generally be taken into account. The predicted modes variance is then ascertained as the mean value of the calculated variances over all T=3 time steps and all K=3 behavior options.

$${σ}_{x , y} = {\sum }_{k = 1}^{K} {\sum }_{t = 1}^{T} \frac{{σ}^{2} ( {x}_{t , k} ) + {σ}^{2} ( {y}_{t , k} )}{TK}$$

Variance can, for example, be simply induced into the prediction by applying different types of noise to the input data of the prediction, i.e., the currently aggregated scene-specific information, for the different predictions. Another possibility is to modify any or specific weights of the prediction component for the different predictions with a predetermined probability p or to set them to zero. For example, a Monte Carlo dropout method may be used for this purpose. As an alternative, several different prediction components may also be used, in particular several architecturally equivalent prediction components that differ in the parameters learned because they were, for example, trained with different compositions of the training data. The predictions of all prediction components will then be partially different so that the variance of the predictions can be calculated.

In contrast to the variance-based metric explained in connection with FIG. 2, which metric can be used universally for any AI-based prediction modules, the reconstruction error metric explained below in connection with FIG. 3 can only be used if a reconstruction component is also available in addition to the prediction component. An example of an architecture having a prediction component and reconstruction component is the self-supervised action-space predictor (SS-ASP) described in Janjos et al., “Self-Supervised Action-Space Prediction for Automated Driving,” arXiv, 2109.10024, 2021.

A prerequisite for using the reconstruction error metric is that the behavior of a participant in a future time segment i+1 is predicted, viz., for each behavior option, starting from the actual or predicted behavior of the participant in the previous time segment i. In this case, the previous time segment i can in principle be in the past or in the future.

The determination of the reconstruction error Δreco is explained below using autoregressive multi-segment prediction. For each future time segment Ŷᵢ₊₁, a prediction is carried out, in which the trajectory Yin is determined on the basis of the data of the previous time segment and on the basis of the current scene-specific information. Simultaneously, the trajectory Ýᵢ of the previous time segment i can be reconstructed by means of a reconstruction component on the basis of the predicted trajectory Ŷᵢ₊₁ and any additional predicted data, such as a latent representation of the future time segment. Predictions and reconstructions for the time segment i can then be compared and a reconstruction error Δreco can be determined for the time segment i. Since this reconstruction error is ascertained on the basis of the current prediction for the time segment i+1, it can be used to quantize the current epistemic uncertainty of the prediction for the time segment i+1.

In the case that only one segment is predicted, i.e., the entire future trajectory is estimated in a so-called one-shot prediction (i=1), the reconstruction can be compared to the past trajectory Y0 of the agent.

$${Δ}_{reco} = \{ \begin{matrix}‖ {\tilde{Y}}_{i} - {\hat{Y}}_{i} ‖ & i \geq 1 \\ ‖ {\tilde{Y}}_{i} - {\hat{Y}}_{i} ‖ & i = 0\end{matrix}$$

FIG. 3 illustrates the comparison between a trajectory 31 reconstructed for a time segment i and a trajectory 32 predicted for this time segment i. The reconstruction error Δ is determined here by first determining a Euclidean distance, or a difference between the corresponding trajectory waypoints, between the trajectories 31 and 32 for each trajectory waypoint of the time segment i, which is indicated here by the double arrows between the two trajectories 31 and 32. A mean value for the entire time segment i is then formed from these distances. However, any applicable distance measure or similarity measure can generally be used for the comparison.

Tests have shown that the two above-described metrics, predicted modes variance and reconstruction error, are very well-suited for quantifying the epistemic uncertainty of DL-based prediction components for predicting behavior.

The current determination of the epistemic uncertainty of prediction components can advantageously be used by a planning component to take into account the predicted future trajectories of the other traffic scene participants in the solution of the planning problem accordingly. In the case of low epistemic uncertainty, the planning component can, for example, simply trust the prediction and treat as non-drivable the space or the areas predicted as occupied by the prediction component. If a high epistemic uncertainty is attached to the predicted trajectories of individual participants, it is also possible to assign additional safety areas to these road users, which safety areas are then likewise treated as non-drivable by the planning component. Taking the epistemic uncertainty of the prediction into account in this way improves the planning and thus increases the safety of automated driving maneuvers.

Furthermore, the quantification of the epistemic uncertainty of the prediction can advantageously be used to determine the system limits of the automated vehicle. For example, if a high uncertainty is attached to the current prediction of the prediction component, transfer to the driver can be requested in order to avoid situations in which the system might respond incorrectly.

What is claimed is:

1. A computer-implemented method for predicting a behavior of at least one participant in a traffic scene, the method comprising the following steps:
predicting, using at least one AI-based prediction component, a specified number of individual behavior options of the at least one participant for at least one future time segment based on scene-specific information which are aggregated at a current time point, wherein each of the at least one future time segment includes a specified number of consecutive time points; and
determining, in parallel to the prediction of the individual behavior options, at least one current overall uncertainty value that quantifies an epistemic uncertainty of all of the predicted individual behavior options for the at least one future time segment.

2. The method according to claim 1, wherein, for each of the predicted individual behavior options, at least one respective current uncertainty value that quantifies an epistemic uncertainty of the predicted individual behavior option is determined, and that the current overall uncertainty value is determined based on all of the current uncertainty values.

3. The method according to claim 2, wherein, for each of the predicted individual behavior options, several different predictions are generated based on currently aggregated scene-specific information, and, for each of the predicted behavior options, the respective current uncertainty value is determined based on the different predictions.

4. The method according to claim 3, wherein, for each of the predicted individual behavior options, the respective current uncertainty value is determined as a mean value of variances between the different predictions over all time points of the at least one future time segment.

5. The method according to claim 3, wherein the several different predictions for each of the predicted individual behavior options are generated based on the currently aggregated scene-specific information by applying different types of noise to the currently aggregated scene-specific information for the different predictions.

6. The method according to claim 3, wherein the several different predictions for each of the predicted individual behavior options are generated based on the currently aggregated scene-specific information by modifying weights of the prediction component for the different predictions with a predetermined probability and, by setting them to zero.

7. The method according to claim 3, wherein the several different predictions for each of the predicted individual behavior options are generated based on the currently aggregated scene-specific information by using several different prediction components including several architecturally equivalent prediction components, which differ in parameters learned.

8. The method according to claim 2, wherein, for each of the predicted individual behavior options, a behavior of the at least one participant in a future time segment i+1 is predicted starting from an actual or predicted behavior of the participant in a previous time segment i, wherein:
the behavior of the participant in the previous time segment i is reconstructed based on a behavior predicted for the future time segment i+1,
the behavior reconstructed for the time segment i is compared either to the actual behavior of the participant in the time segment i if the time segment i is in the past, or to the predicted behavior of the participant for the time segment i if the time segment i is in the future, and
a current uncertainty value for the time segment i+1 is determined based on the comparison.

9. The method according to claim 8, wherein further data aggregated and/or predicted in the past are taken into account in the reconstruction of the behavior of the participant in the previous time segment i.

10. The method according to claim 1, wherein the predicted behavior options are predicted in the form of trajectory data including position data and/or movement data and/or orientation data, for each time point of the at least one future time segment.

11. A computer-implemented system configured to predict a behavior of at least one participant in a traffic scene, the system being configured to:
predict, using at least one AI-based prediction component, a specified number of individual behavior options of the at least one participant for at least one future time segment based on scene-specific information which are aggregated at a current time point, wherein each of the at least one future time segment includes a specified number of consecutive time points; and
determine, in parallel to the prediction of the individual behavior options, at least one current overall uncertainty value that quantifies an epistemic uncertainty of all predicted individual behavior options for the at least one future time segment.
